(19) United States
(12) Patent Application Publication
(10) Pub. No.: US 2017/0091208 A1
(43) Pub. Date: Mar. 30, 2017

(54) SYSTEMS AND METHODS FOR MANAGING, SHARING, AND ORGANIZING INFORMATION STORED ON MULTIPLE CLOUD SERVICES

(71) Applicant: Dennis Quan, Cary, NC (US)

(72) Inventor: Dennis Quan, Cary, NC (US)

(21) Appl. No.: 15/311,177

(22) PCT Filed: May 13, 2015
(86) PCT No.: PCT/US15/30674

§ 371 Date: Nov. 14, 2016

Related U.S. Application Data
(60) Provisional application No. 61/992,466, filed on May 13, 2014.

(51) Int. Cl. G06F 17/30; G06F 3/0484; G06F 3/0482

(52) U.S. Cl. CPC G06F 17/30091; G06F 3/0482; G06F 3/0484; G06F 17/30115

(57) ABSTRACT

This invention relates to systems and methods for accessing, managing, sharing, and organizing information stored on multiple cloud services, particularly to accessing and managing large numbers of documents and/or files stored across multiple cloud services while providing efficient, intuitive and accessible organization for the documents and/or files without separately logging in or accessing each of the locations, each time. In general, a user may utilize multiple cloud services, which may include remote private servers as well as mainstream public services, and may generally store files and/or documents across the multiple cloud services.

### CROSS-REFERENCE TO RELATED APPLICATIONS

This application claims the priority and benefit of U.S. provisional patent application Ser. No. 61/992,466, filed May 13, 2014, entitled “SYSTEMS AND METHODS FOR MANAGING, SHARING, AND ORGANIZING INFORMATION STORED ON MULTIPLE CLOUD SERVICES”, the contents of which is hereby incorporated by reference in its entirety.

### FIELD OF THE INVENTION

This invention relates to systems and methods for managing, sharing, and organizing information stored on multiple cloud services, particularly to systems and methods for managing large numbers of documents and/or files stored across multiple cloud services while providing efficient, intuitive and accessible organization for the documents and/or files.

### BACKGROUND OF THE INVENTION

Increasingly, people generate data and metadata across multiple computing devices and multiple hosted services. For example, during the course of a single day, a person may use a laptop computer, desktop computer, tablet computer, and/or smartphone in order to create, view and edit files, for example, photos, e-mails, or other data objects. As another example, a person may use hosted solutions such as Facebook, Instagram, Twitter, Dropbox, Flickr, Google Drive, Box, and OneDrive to communicate with others and conduct work. A person may not be able to easily access the files and information they need readily from a single interface, since the files are scattered across multiple computing devices and hosted sites. Moreover, conventional information management systems are often focused on organizing, protecting, and recovering the data from fixed computing devices, such as servers or desktop computers. As a result, a person's hosted data and mobile data may be scattered outside of the purview of conventional information management systems. Thus, many users may be unable to locate, share or otherwise manage their files and/or documents readily without tediously examining all of their cloud services.

### SUMMARY OF THE INVENTION

This invention relates to systems and methods for accessing, managing, sharing, and organizing information stored on multiple cloud services, particularly to accessing and managing large numbers of documents and/or files stored across multiple cloud services while providing efficient, intuitive and accessible organization for the documents and/or files without separately logging in or accessing each of the locations, each time.

In general, a user may utilize multiple cloud services, which may include remote private servers as well as mainstream public services, and may generally store files and/or documents across the multiple cloud services. Cloud services may often have storage limits or may be used for specific types of activities or purposes, and thus a user may have files and/or documents spread out across the multiple cloud services rather than in a centralized place. A user may also employ some local storage, such as on the particular devices the user employs, such as, for example, a smartphone, a tablet computer, a personal computer, and/or any other common device. Files and/or documents may include, but are not limited to, photos, text files, presentations, documents, images, and/or any other appropriate computer file or document.

The present invention enables the user to access, view and manage all the information as easily as if they were all stored in one location.

In one exemplary embodiment, a system and method for managing information files stored on multiple computer storage facilities, such as cloud services and/or locally accessible storage, by a user without separately logging in or accessing each of the locations, each time by the user, includes downloading a computer app onto a device for accessing any electronic storage facility or service. The app may be utilized to access the various computer storage facilities through a proper access avenue, such as an application programming interface (API), for each particular storage facility. The accessible information may then be displayed to the user within the app.

In one aspect of the present invention, a computer application (app) may be utilized to access and view the files and/or documents accessible to a user that may reside on multiple cloud services in a single unified app interface, which may be desirable as it would not require the user to log in or access each individual cloud service separately, each time. For example, the app may allow the user to enter the log in or access information at a setup stage and from then on the app would provide access to the user without further direct interaction between the user and the particular cloud service. This is comparable to being able to stand at one location and yet able to get information out of filing cabinets or buildings at different places without actually moving about to the different locations. The app may generally be utilized on any appropriate device, which may include, but is not limited to, a smartphone, a tablet computer, a personal computer, and/or any other appropriate computing device. In general, the app may employ a graphical user interface (GUI) and depending on the device, it may be accessible with a touchscreen interface and/or a keyboard/mouse interface, whichever may be appropriate. The app may also employ other forms of interface, such as those designed for use with visually and/or hearing impaired users, and/or alternative interfaces, which may include, for example, voice recognition and/or playback, Braille computer interfaces, haptic interfaces, and/or any other appropriate interface. The app may also display any local files and/or documents on the particular device on which the user is viewing the app. The accessible files and/or documents of the user may be presented in a listing and/or graphical display. The agglomeration of all of the accessible files and/or documents of the user available in the app may generally represent a library of files and/or documents. In some embodiments, the app may access the cloud services through a proper application programming interface (API) for each particular cloud service, and may display all of the accessible files and/or documents to the user within the app. In some embodiments, the app may access the files and/or documents on the computer storage facilities, such as the cloud services, but may generally not modify, permanently download, or move any of the files and/or documents from the cloud service on which they reside. Thus, the files and/or documents may also be used normally from the cloud service on which they reside without being affected by the app. In other embodiments, the app may have some ability to manipulate the files and/or documents stored on a computer storage facility such as a cloud service, such as moving between services, deleting, copying between services, managing duplicates/versions/similar files and/or documents, editing, and/or any other appropriate or allowed manipulations, as such may depend on what is allowed by the API of the cloud service. As used herein, any mention of cloud services may also be applicable to any other computer storage facility and/or media services .

In some embodiments, the app may be utilized by a user for management of files and/or documents on various public cloud storage, cloud social media services, such as, for example, Facebook, Instagram, Twitter, Dropbox, Flickr, Google Drive, Box, OneDrive, cloud collaboration services, and/or any other appropriate cloud service. This may be desirable as the social media services, collaboration services, and cloud storage space are used for different purposes and are highly segmented, which may generally result in a user needing access to many different cloud services. The app may also include features to manage already extant organizational tools and/or schemes employed by the cloud service and/or storage, such as, for example, albums, folders, collections, marks, tags, hashtags, geotags, and/or other organizational methods. The app may, for example, provide features for syncing of similar and/or identical organizational tools and/or schemes, such as, for example, albums, folders, collections, marks, tags, hashtags, geotags, and/or other commonly employed organizational methods which may largely function similarly. This may be desirable as the user may then perform an organizational task once in the app and then have it mirrored in any of the appropriate cloud services. It may further be desirable as the user may also employ the app to apply an organizational scheme from one cloud service to another cloud service, or elsewhere, via the app.

In other embodiments, the app may be utilized by a user for management of files and/or documents on private cloud services and/or private servers. For example, some professionals may utilize a variety of privately hosted information resources, such as private company servers and/or servers of clients/customers. This may be desirable as different companies and/or clients/customers may utilize different hosted information sources/servers, and/or may wish to maintain overall control of files and/or documents without disseminating them over unsecure channels.

In another aspect of the present invention, the app may include systems and features for providing organization of files and/or documents, such as, for example, by marking files and/or documents with metadata which may contain semantic information. In some embodiments, the metadata generated through the app may be stored locally on the particular device the user is employing and/or the metadata may be stored on a remote server and/or cloud service. For example, the provider of the app may also host a server and/or cloud service to facilitate storage of metadata from the various users of the app. In some embodiments, the metadata may generally not be stored with the actual file on the cloud service on which it resides, but may be stored separately. However, the metadata may still be accessible to the user on any device the user employs the app through access to the remote server and/or cloud service for storing the metadata. In other embodiments, the metadata may be stored at, synced with and/or harvested from the cloud service where the file and/or document originated.

In some exemplary embodiments, the metadata may include a mark, such as, for example, a label, “sticker” or “tag” which may identify the file and/or document as part of a particular subset or category of items. For example, in the context of managing photos or pictures, a tag (or multiple marks) may be utilized to identify the subject matter and/or other significance of a photo or picture. In some exemplary embodiments, the mark may include a graphical and/or illustrative symbol, such as an emoticon, emoji, smiley or similar types of graphical and/or illustrative symbols, which may provide a user with an intuitive way to associate files and/or documents with associative information, such as a particular subject matter, physical location, and/or other significance. The mark may also include, for further example, animations, and/or marks that may be exchanged, bought, sold, bartered, and/or earned from other users, vendors, and/or other entities. For example, a mark may be utilized to assign emotional and/or social significance, such as like, dislike, appreciation, shock, surprise and/or any other appropriate significance. The marks may also be utilized as an alternative method of communicating information about a file and/or document that does not require normal linguistic communication, and may rather be used as a form of graphical “shorthand”. Additionally, the marks may be utilized in an organizational manner along with their communicative value.

In some embodiments, the marks may also represent a new or novel language created for and to be used amongst a group of users for communicating with each other, such as, for example, via a special code, a secret code, an industry/field specific taxonomy, local vernacular/dialect, and/or other appropriate communication format.

In general, marking may also include deleting, retracting, suggesting a deletion and/or suggesting a retraction of a mark in addition to a positive addition and/or suggestion of addition of a mark. The mark may also be a positive or negative value. For example, a mark may indicate or “tag” in a photo the presence of a person or a mark may also indicate that a person is not present (definitively, rather than just not already “tagged”).

The present invention relates to a system for marking information stored on a cloud service. The system includes a user interface on a computing device for displaying, conveying, dictating, a form of presenting that conveys information non-visually and/or creating at least one item of information. The system may also include a selection of marks which may be applied to the item of information. The marks may be used for identifying representation of different subject matters. At least one mark may be chosen from the selection to potentially describe the item of information, and an association between the item of information and at least one mark may be stored on a computing device so that the association stores the metadata describing the item of information about its subject matter. As used herein, the mention of displaying, conveying, also applies to dictating or presentation that works for non-visual conveying of information.

The present invention also relates to a method for marking information stored on a cloud service, by providing a user interface (UI) on a computing device displaying, conveying or creating at least one item of information and a selection of marks which may be applied to the item of information. The selection of marks includes identifying representations of different subject matters. The method may select at least one mark from the selection of marks which potentially describes the item of information to apply to the item of information; and then storing an association between the at least one mark and the item of information on the computing device. The association stores metadata describing the item of information with marking information about its subject matter.

The marks may exist as a preset list in the app and may be augmented and/or modified by the user. Once marked, files and/or documents may be sorted, searched and/or viewed by mark in the app to, for example, allow the user to easily find particular files and/or documents of a particular significance easily without sifting through the files and/or documents en masse. The app may further include features for marking multiple files and/or documents with a given mark without accessing each individual file and/or document. This may be desirable as the visual cues and graphically-oriented organization of files and/or documents may be more desirable or preferable to at least some users over more traditional approaches to file and/or document organization. In some embodiments, the app may also automatically detect appropriate marks and/or mark based on associated information with a file and/or document originating from a social network service and/or cloud service. For example, the app may employ image recognition to determine subject matter and/or people in pictures to apply appropriate marks. The app may also, for example, utilize other information readily stored on the social network service and/or cloud service, such as the service's own version of tagging, hashtagging, geotagging, marking and/or other information association, such as metadata embedded within the files themselves.

Marks may also be employed at the onset of creation of a file and/or document, rather than being added after the fact. For example, the app may include a feature for applying a mark and/or selecting a set of marks to be applied while creating multiple files and/or documents in succession for which the mark(s) should apply. For further example, a user may designate a mark and/or a set of marks to apply to a series of photos the user is about to take using the app. The app may then apply the mark(s) as the photos are taken instead of the user going back after the photos are taken to apply the marks. This may be desirable, for example, when creating files and/or documents in a particular situation where a mark or set of marks may generally apply to all of the files and/or documents being created, such as, for further example, when a user is taking a series of photos at a particular event or of a particular subject or multiple members of a team working on the same project. In one embodiment, the app may interface with the file- and/or document-creating application or feature of a computing device, such as, for example, a camera, document creating/editing application such as creating a joint power point presentation or progress in project management, information capture device, and/or any other appropriate application or feature. The setting of a mark and/or set of marks to apply while creating may then be chosen directly with the application or feature. In one example, the camera function of a computing device may include a plugin and/or other interface which enables a user to select a mark(s) to apply for the photos about to be taken.

In general, marking of files and/or documents, along with other information associated with the files and/or documents, may be utilized to generate filtered views of the available files and/or documents to be displayed to the user. Other information about the files and/or documents may include, for example, the source, date(s) associated, size, file type, marks, and/or any other appropriate information. For example, a user may utilize the app to filter files and/or documents and show only those from a particular set of cloud services having certain marks.

In other exemplary embodiment, the metadata may include a mark which may identify the file and/or document as part of a particular subset or category of items with different assigned weight(s) and/or significance(s). Any user may organize the files by assigning different or same weight(s) and/or kind or level of significance(s) to the files without disturbing the original file or document, to generate his/her own, for example, decision tree or presentation. In another example, a user may assign weight(s) and/or kind or level of significance(s) to particular marks which may indicate how the user values certain types of information about a file and/or document.

In a further aspect of the present invention, the app may include features for displaying an agglomeration of files, documents and/or social media postings collected from the multiple cloud services of a user. This may generally enable the user to view an up-to-date and/or near real-time feed of updates occurring on the various multiple cloud services. In some embodiments, the app may include a social media feed which may display posts and/or updates from the social media services the user employs, such as, for example, Facebook®, Twitter®, Instagram®, Google+®, and/or any other appropriate social media service. The app may further update the feed at intervals and may keep the feed up-to-date in near real time and/or real time. The app may also include features for customizing the update interval to a desired timing, and/or features for customizing the filtering tools, such as to see relevant subsets of files, documents and/or other information.

In some embodiments, the feed may contain updates, posts and/or files from multiple social media services, and/or a selection thereof. Some social media services may provide posts and/or files from other users, which may be displayed in the app. The app may also include features for saving the posts, links, links to files, and/or files from other users into the library available in the app. The app may also provide accessibility to social media interaction, such as “liking”, “commenting”, “sharing”, and/or any other appropriate interaction, depending on the applicable social media service.

In still another aspect of the present invention, the app may include systems and features for sharing files and/or documents with other users. In some embodiments, the app may include a messaging and/or chat interface which may enable a user to communicate with another user of the app, and may also enable a user to share files and/or documents with another user of the app. In some embodiments, the app may also enable the user to share files and/or documents with others who are not employing the app, such as, for example, providing a direct link to the file and/or document and/or the folder(s) or location(s) containing the file and/or document via e-mail and/or other appropriate message. Other information may also be exchanged, such as the marks associated with the file and/or document, as discussed above, which may be shared automatically or manually. New files and/or documents may also be created in the context of the communication, such as, for example, creating a file and/or document during the course of the communication, such as taking a photo, as opposed to, for example, only working with files and/or documents created prior to the start of the communication exchange. In general, the communication may occur in real time and/or near real time, such that users of the app may act as if files and/or documents created by any user in the communication may be immediately accessible to everyone in the communication, including any associated information, such as marks, as discussed above. Transfers (i.e., file copies) may also be accomplished with the app across different cloud services, and may be done automatically when needed to, for example, enable multiple users to see the files and/or documents, even if there are pairs of users in the communication that may not share common cloud services. For example, one user may be utilizing a first cloud service and a second user may be utilizing a second cloud service, where the users do not use a common cloud service. The app may then facilitate transfer from the first cloud service to the second and/or vice versa to accommodate the users not using the same cloud services. This may be desirable as users may have the flexibility to retain copies and/or links in their libraries to information exchanged through a communication session.

In general, many users of smartphones and other mobile devices are subject to data plans for internet access which may include limits on bandwidth and/or data transfer. It may thus be desirable for a sharing function of the app to include features for limiting the use of a mobile device's data plan while optimizing use on unlimited and/or less limited connections to the internet, such as, for example, WiFi hotspots, home or office internet connections and/or any other available internet access for which there are fewer or no data transfer restrictions. In some embodiments, the app may share a preview, a thumbnail, a portion of, and/or any other appropriate abbreviated version of a file and/or document in a message and/or chat to another user while the user is on a limited data connection. The user may elect to view the entire file and/or document while on the limited data connection, or the user may also wait to view the entire file and/or document while on an unlimited and/or less restricted internet connection. The app may also, for example, queue up operations to be performed when the user is on an unlimited and/or less restricted internet connection, and execute the queued up operations on behalf of the user when an unlimited and/or less restricted internet connection is detected. This may be desirable as it may allow users to perform actions at their convenience, such as when they are on a limited data connection, without having to remember to execute the operations later when they are on an unlimited and/or less restricted internet connection.

In some exemplary embodiments, a user may interact with the files and/or documents of another user via a social network and/or cloud service in the same manner as the user's own files and/or documents. For example, the app may include features for allowing a user to mark, such as described above, the files and/or documents of another user. In general, marking may also include deleting, retracting, suggesting a mark be added, suggesting a mark be absent, retracting the deletion of a mark, suggesting retraction of the deletion of a mark and/or retracting a suggestion about the presence of a mark. This may be desirable, for example, to enable social interaction between users via marking each other's files and/or documents. For further example, users may assist each other in marking files and/or documents. This may, for example, be used to distribute the management and/or organizational load among many users, such as in a team working on the same project in any corporate setting. There may also be a social interaction value, as some users may be more inclined to organize and mark files and/or documents than others. Different users may also associate different information with files and/or documents. For example, a photo may have a particular significance to one user, but it may have a different significance to another user. The app may thus allow the multiple users to mark the photo accordingly. Also, some users may notice information about a file and/or document that other users may not, and thus the additional information may be utilized with multiple users. For example, a user may not notice the presence of an item of interest in a photo, but another user may notice and mark the photo accordingly. The app may further include features for resolving conflicts between the markings made by different users, such as discussed further below. The app may also include features for tracking multiple users marking a file and/or document in the same way or with the same mark, which may be used, for example, to weight or value the confidence of a mark, or, for further example, as a voting mechanism for whether a given mark should apply to a given file and/or document, such as by gauging popularity by the number of votes for a particular mark. The marks may also be propagated back from the app to the social network and/or cloud service where the file and/or document originated. The back propagation may be controlled by the user and/or through a setting and/or control in the app such that the distribution of the marking information may be limited, such as, for example, for privacy control of the marking information.

In some embodiments, the cooperative marking of files and/or documents may also be associated with a social interaction activity and/or game. For example, a user may be awarded some value for marking the files and/or documents of others in a positive manner.

In yet another aspect of the present invention, the app may include features for enabling a user to review and/or recollect information stored within the files and/or documents accessed by the app. In some embodiments, the app may be utilized to recall a selection of information from the past activities of a user, such as, for example, recalling a selection of social media posts and/or images. The app may also be utilized to recall a selection of information based on filtering for marks and/or other organizational information. In another example, the app may display a selection of images in a visually appealing manner, such as, for example, in the form of a slideshow, moving picture tiles and/or any other appropriate display of images, which may appear in a two-dimensional format, a simulated three-dimensional format, and/or a combination of both. The app may thus also be used to allow a user to reminisce over information from the past in a visually appealing way. This may also be desirable to share such information with others by presenting it to them from the app in a visually appealing way rather than, for example, in a more structured manner, such as with a file folder hierarchy and/or other less aesthetically pleasing display. The app may also track the viewing and/or usage of files and/or documents by the user to make determinations about how to display information for reminiscing, such as, for example, how often and how recently such information has been viewed.

In still another aspect of the present invention, the app may include systems and features for detecting and managing duplicates and/or versions of files, documents and/or other information, as well as detecting and managing files, documents, and/or other information that may be similar. In general, duplicates and/or versions of files, documents and/or other information may exist relatively unintentionally as a result of using multiple social networking services and/or cloud services to keep and/or disseminate information, such as, for example, by posting a photo to multiple different social networks. Duplicates and/or versions of files, documents and/or other information may also exist for the purpose of backing up the files, documents and/or other information.

In one embodiment, multiple copies and/or versions of a particular file, document and/or information may be present on multiple cloud services and/or social networks employed by a user. The app may generally detect similarity and may further, for example, group such similar files, documents, and/or information together within the app. This may be desirable such that the user may better manage information without being faced with duplicates and/or versions displayed in multiplicity. The app may also, for example, include features for managing duplicates and/or versions. For example, the app may enable the user to show/hide duplicates and/or versions, show statistics for levels of duplication and/or versioning, detect the quality, truncation and/or completeness of a duplicate and/or version, intentionally create duplicates for backup purposes or for publishing/dissemination, allow the user to determine if duplication actually exists between candidates the app has detected, cloning of organizational and/or marking information across duplicates and/or versions, and/or any other appropriate management operations. The app may also, for further example, collect and/or display associated information about the various duplicates and/or versions from their various sources. For example, in a social media context, the app may collect comments, “likes”, “tags”, “hashtags”, “geotags”, and/or other information associated with duplicates and/or versions of a file, document, and/or other information from varied sources and coalesce them into one set of associated information for the user to view and manage. This may be desirable, for example, to allow the user to more easily collect and process feedback for a single piece of information from varied social networks and/or cloud services by associating them together. The coalesced associated information may also be utilized by the app to affect marking within the app, as discussed above. Coalesced associated information, including that inputted by the user after the files/documents being marked up with said associated information are identified and/or notated as duplicates/versions, may also be associated with each individual duplicate and/or version so as to ensure that queries for specific marks and/or other associated information recall all duplicates and/or versions.

In some embodiments, the app may also allow a file, document and/or other information to be disseminated across various social networks and/or cloud services by creating multiple duplicates and/or versions to upload and/or post. For example, the app may post and/or upload a single original file, document and/or other information to multiple cloud services to create the multiple duplicates and/or versions spread among the multiple cloud services. The app may further track these duplicates and/or versions from their initial creation to collect and/or coalesce associated information from the duplicates and/or versions as they arise. This form of purposeful and/or intentional dissemination of duplicates and/or versions may thus be utilized to reach more audience while retaining agglomeration of any associated information, such as comments, feedback, likes”, “tags”, “hashtags”, “geotags”, and/or other information associated with duplicates and/or versions.

In some embodiments, the app may also automatically disseminate duplicates and/or versions based on particular settings, such as, for example, based on marking of a file, document and/or other information. The user may further determine rules and/or situations where automatic dissemination should occur and to what social media services and/or cloud services the dissemination should include. The app may also automatically detect when such dissemination should occur and may also prompt the user to allow such automatic dissemination. For example, if the app detects the addition of files, documents and/or other information which is normally disseminated, the app may prompt the user to allow automatic dissemination.

In yet another aspect of the present invention, the app may include systems and features for creating and storing of a compilation of files contributed by various users at various times from same or different devices in one or multiple private and/or public clouds. In one embodiment, the compilation may be manipulated and organized, for example, by a designated user(s) to generate a presentation to be accessed and viewed simultaneously by invited users. In another embodiment, the compilation may be manipulated and organized, for example, by any user to generate a presentation or booklet to be accessed and viewed simultaneously by invited users without disturbing the original compilation.

In yet a further aspect of the present invention, the app may include systems and features for automatically storing of files that have been marked for a particular location in that location or marked with a weight, or a kind or level of significance in the location with the particular significance. A user or multiple users may cooperatively work on or create files simultaneously or at different times, for example, by any member of a team on the same project.

In some aspects of the present invention, the app may include features for managing attributes, properties and/or other metadata about the files and/or documents in the library, which may include, but are not limited to, associated dates, content, physical locations, subject matter, comments, feedback, associated information, such as the marks discussed above, including emoji, smileys, “likes”, “tags”, “hashtags” and/or “geotags”, and/or any other appropriate information. The app may also include features for correcting errors, adjusting consistency between potential duplicates and/or versions, inputting missing information, and/or importing/exporting metadata between the app, cloud services, social networking services and/or any combination thereof.

In one aspect of the invention, the app may store and handle metadata, such as the types discussed above, about the files and/or documents in the library by being configured to organize, assess, and/or apply different types of logical assertions made by an agent about a file and/or document accessed by the app. The assertions may thus function within the app as representations of the underlying metadata the assertions describe. The agent may be a hosting service, a social network, a part, entirety, or any combination thereof of the app itself, the user, another user, such as discussed above in regards to multiple users performing marking, and/or any other appropriate entity providing information about the file and/or document. These assertions may then, for example, be utilized by the app to enable and/or govern organizational behavior in the app, such as with the marking and/or duplicate/versioning handling, as discussed above.

In general, the assertion may include information about the file and/or document which may be accessible by the app, which may further be used by the app to make determinations of attributes of the file and/or document, depending on the property of interest of the file and/or document, the value of the said property, and/or the mode of assertion being made. The assertion may also include information about other forms of information, such as the marks used in the app, other data, abstract information, indications of duplication/versioning, and/or any other appropriate information for which an assertion may be made. Assertions about other forms of information may generally function in a similar and/or identical fashion to assertions about files and/or documents, as discussed below. The underlying metadata may generally be stored in the form of assertions representing the metadata, which may themselves be stored locally on the particular device the user is employing and/or the assertions may be stored on a remote server and/or cloud service. For example, the provider of the app may also host a server and/or cloud service to facilitate storage of assertions representing metadata from the various users of the app, such as in a database or data structure. In some embodiments, the assertions about a file may generally not be stored with the actual file on the cloud service on which it resides, but may be stored separately. However, the assertions may still be accessible to the user on any device the user employs the app through access to the remote server and/or cloud service for storing the assertions. In other embodiments, the assertions may be stored at, synced with and/or harvested from the cloud service where the file and/or document originated, such as by utilizing an available storage mechanism of the cloud service.

In some embodiments, the assertion may be a property assertion and assert a property of a file and/or document that has a singular value. This assertion may include information about the agent, file and/or document being accessed, property of said file and/or document, value of the said property, timestamp of when the assertion was recorded, timestamp of when the assertion was made (i.e. when the assertion became true and/or took effect), physical location of the agent when the assertion was recorded, physical location of the agent when the assertion was made and/or any other relevant attributes. Property assertions may, for example, generally be utilized for marking and/or to govern how marks are applied, as discussed above.

In some embodiments, the assertion may be a multiple property assertion and assert a property of the file and/or document that has multiple values. This assertion may include information about the agent, file and/or document being accessed, property of said file, file and/or document being accessed, property of said file and/or document, value of the said property, timestamp of when the assertion was recorded, timestamp of when the assertion was made (i.e. when the assertion became true and/or took effect), physical location of the agent when the assertion was recorded, physical location of the agent when the assertion was made, order of the file and/or document in relation to other files and/or documents that are also values of the same property, and/or any other relevant attributes. Multiple property assertions may, for example, generally be utilized for marking and/or to govern how marks are applied, as discussed above.

In addition, if desired, the multiple property assertions may also include location specificities such as for example, where the file was created, marked or viewed, potentially allowing location tracking of a user.

In some embodiments, the assertion may be called an equivalence assertion and assert that more than one file and/or document accessed by the app are the same, equivalent and/or similar enough to warrant association. This assertion may include information about the agent, file and/or document being accessed, equivalence class, second file and/or document that is equivalent, timestamp of when the assertion was recorded, timestamp of when the assertion was made (i.e. when the assertion became true and/or took effect), physical location of the agent when the assertion was recorded, physical location of the agent when the assertion was made, and/or any other relevant attributes. Equivalence assertions may, for example, be utilized for assessing and/or governing the handling of duplicates, versions and/or other similarities between multiple files, documents and/or other types of information, as discussed above.

In some embodiments, an assertion may carry Boolean values which identify the mode of assertion being made by an agent. For example, an assertion may carry a Boolean value for whether the assertion is retracting a previous assertion. This may be desirable as the retracting assertion may delete the previous assertion being retracted, while preserving the information contained about the previous assertion, thus allowing historical tracking of assertions made against a file and/or document in the app. In another example, an assertion may carry a Boolean value for whether the assertion being made is a positive assertion or a negative assertion, such as, for further example, asserting whether a particular property and/or value is present or not present. For further example, in one embodiment, an assertion may be made about a photo where an agent asserts that a particular person is in the photo, which would be a positive assertion of a property and/or value. Another assertion may assert that another person is not in the photo, which would be a negative assertion of a property and/or value. This may be desirable, for example, as such an assertion is unambiguous as compared to a deduction that a person is not in the photo simply due to the lack or absence of an assertion that the person is in the photo.

In another aspect of the invention, the app may be configured to provide for the capability to carry out a multi-way synchronization of files and/or documents. For example, the app may combine the assertions from different sources, devices, services and/or users together.

In some embodiments, the app may also be configured to allow for information to be manipulated in the app while the app is disconnected from a social network, cloud service and/or the internet, such that the user may utilize the app while not connected. For example, the app may be utilized in this manner while the user is in an internet deadzone, while traveling where internet connections and/or service connections are limited, restricted and/or unavailable, onboard an aircraft, and/or any other situation where connectivity is limited, restricted and/or unavailable. The app may then synchronize with the social network, cloud service and/or service for syncing and/or storing metadata when the user returns to connectivity.

In some embodiments, the app may generally include well-defined semantics regardless of concurrent modifications, such as, for example, by providing rules and/or hierarchy for dealing with agent priority in making changes and/or assertions, such that any conflicts may be resolved by the app. For another example, the app may combine and/or add assertions from various sources together. In another example, the user and/or the last modification and/or assertion in time may have priority over others. In a further example, multiple property assertions may be made by different parties and/or in different places, which may then be merged with minimal and/or no ambiguity or conflict as the multiple property assertions may inherently provide for multiple values even from different sources and/or locations.

In some embodiments, the app may generally include an ability to backtrack to see why a certain property is recorded a certain way, such as with the history stored with retractions, as above. In another example, the app may display a reasoning chain and/or inference(s) of why a property is recorded in a certain way. For example, with a photo taken on a first date, modified on a second date, and posted on a third date, the app may infer that the proper date for organization purposes is the second date, based on an inference that the modification date has priority over the taken date and/or the posted date. This may be employed, for example, with a plurality of property value assertions to discriminate various timestamps.

In some embodiments, the app may generally include support for multiple trust levels so that properties asserted by agents of lower trust levels can be overridden by the user, which is an agent of the highest trust, even if an agent of lower trust asserts the property again.

In general, the app may also include features for notifying the user of changes to files, documents and/or other information within the app, such as, for example, addition/changes/deletions/retractions of marks, chats, detection of duplication, requests for interaction from other users, and/or any other appropriate notification.

Without wishing to be limiting, one way to perform duplicate detection is for example, to take the average color value of the image or divide the picture into a fixed number of sections and take the average color values of those sections. Similar or identical pictures will have similar or identical color values. This can be done in conjunction with a metadata comparison to see, for example, if the time stamps of two pictures are identical. There are other, more algorithms including more sophisticated algorithms for doing duplicate detection relative to the simple method outlined above.

The present invention together with the above and other advantages may best be understood from the following detailed description of the embodiments of the invention and as illustrated in the drawings.

### BRIEF DESCRIPTION OF THE FIGURES

FIG. 1 illustrates an exemplary user interface (UI) arrangement of a social media feed;

FIGS. 1a and 1b illustrate an exemplary user interface (UI) arrangements of a social media feed which includes tagging;

FIG. 1c illustrates an exemplary user interface (UI) arrangement of a subset of a social media feed showing tagging by other users;

FIG. 1d illustrates an exemplary user interface (UI) arrangement of a particular item of a social media feed showing tagging;

FIG. 2 illustrates an exemplary user interface (UI) arrangement of a listing of photo chats;

FIG. 3 illustrates an exemplary user interface (UI) arrangement of a photo chat session;

FIGS. 4 and 4a illustrate exemplary user interface (UI) arrangements of a timeline view of a library of photos, sorted by year the photos were taken;

FIG. 4b illustrates an exemplary user interface (UI) arrangement of a subset of a library of photos showing potential duplicates;

FIG. 5 illustrates an exemplary user interface (UI) of a timeline view of a library of photos, sorted by year and month the photos were taken;

FIG. 5a illustrates an exemplary user interface (UI) of a timeline view of a library of photos, sorted by year and month the photos were taken, and by specific criteria;

FIG. 6 illustrates an exemplary user interface (UI) arrangement of photo tagging;

FIG. 6a illustrates an exemplary user interface (UI) arrangement of photo tagging in a library of photos showing duplicates by source and tags already applied; and

FIG. 7 illustrates an exemplary user interface (UI) arrangement of photo tagging of a single photo.

### DETAILED DESCRIPTION OF THE INVENTION

The detailed description set forth below is intended as a description of the presently exemplified systems, devices, methods and materials provided in accordance with aspects of the present invention, and it is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any systems, methods, devices and materials similar or equivalent to those described herein can be used in the practice or testing of the invention, the exemplified systems, methods, devices and materials are now described.

This invention relates to systems and methods for accessing, managing, sharing, and organizing information stored on multiple cloud services, particularly to accessing and managing large numbers of documents and/or files stored across multiple cloud services while providing efficient, intuitive and accessible organization for the documents and/or files without separately logging in or accessing each of the locations, each time.

Storing physical files may involve the utilization of multiple filing cabinets or buildings. This may be due to limited capacity of individual cabinet or building so that a finite number of files or documents may be stored in each cabinet or building, no matter the size of the cabinet or building, and multiple cabinets or buildings are needed for more files. The utilization of multiple filing cabinets or storage buildings for files or documents may also be for separate subject matter or purpose.

Storing electronic information is not unlike storage of physical files or documents in filing cabinets or storage buildings. In general, a user may utilize multiple cloud services, which may include remote private servers as well as mainstream public services, and may generally store files and/or documents across the multiple cloud services. Cloud services may often have storage limits or may be used for specific types of activities or purposes, and thus a user may have files and/or documents spread out across the multiple cloud services rather than in a centralized place. A user may also employ some local storage, such as on the particular devices the user employs, such as, for example, a smartphone, a tablet computer, a personal computer, and/or any other common device. Files and/or documents may include, but are not limited to, photos, text files, presentations, documents, images, and/or any other appropriate computer file or document.

For access to physical files stored in multiple cabinets or buildings, it may be much more cumbersome than access to information in a single file cabinet or building, even with the best cross-referencing system. For example, one may have to physically go to different file cabinets or building to gain access to these physical files. Not unlike access of physical files or documents, where access to information in these computer files and documents across different cloud services and others may also be more cumbersome. For example, one may have to log into different cloud services separately for access.

The present invention enables the user to access, view and manage all the up-to-date information as easily as if they were all stored in one location, for example, without separately logging in or accessing each of the locations, each time.

As mentioned above, this is like able to stand at one location and yet able to get information out of filing cabinets or buildings at different places without actually moving about to the different locations, which is physically impossible, no matter how many times prior one has already been in all the filing cabinets or been to all the buildings, and one has already stored in one location all the different combination of information one would like.

In one exemplary embodiment, the system and method for managing information stored on multiple computer storage facilities, such as cloud services and/or locally accessible storage (local storage), by a user without the user separately logging in or accessing each of the computer storage facilities each time, The computer app may then be utilized to access the various storage facilities through a proper access avenue, such as an application programming interface (API), for each particular storage facility. In general, the app may establish the sources of information files, such as documents, images, etc., that are to be organized, and automatically capturing the available metadata about the information files via access avenues, such as APIs, provided by the storage facilities, provided by the user or other users and/or metadata embedded in the information files themselves and storing the metadata as a series of assertions for use by the app, such as in a database or data structure which may be stored remotely from the information tiles or at the same storage facility. The user may be able to edit/modify/retract assertions, for example, by adding new assertions that state new information or retract old information. Retrieving information files may be based on metadata such as date/time and tags and viewing them in a sequence on the screen, by interpreting assertions in the database relative to their priority to deduce the implied metadata that the user believes is true. Metadata may be propagated between the device(s) and the storage facilities that simple aggregation of new assertions made since the last synchronization. Information files and/or associated metadata may be propagated to different services via their APIs to make the information available to others and/or for backup/archival purposes. Assertions may be interpreted (in the same manner as above) into a set of implied metadata that may then be propagated to a storage facility (since most services are not as assertion-based).

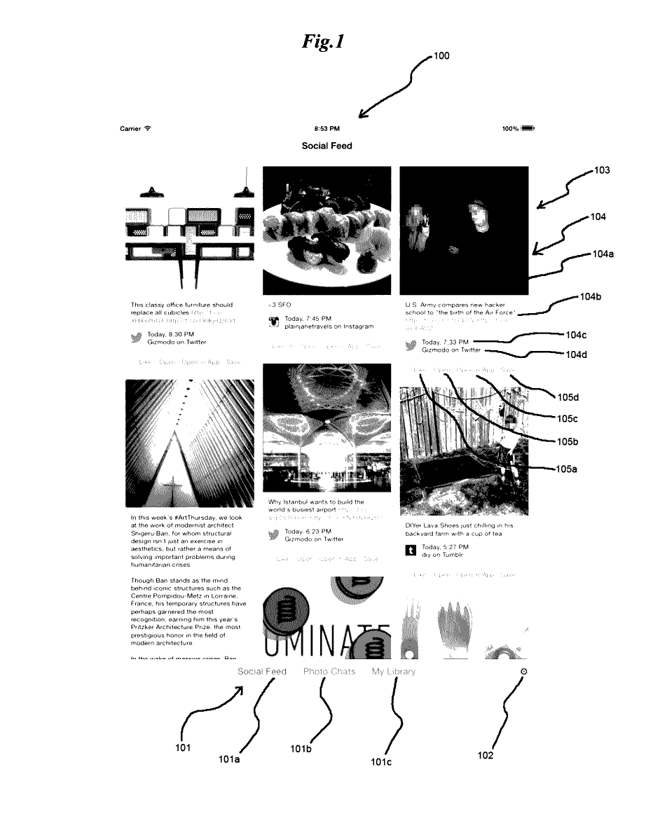

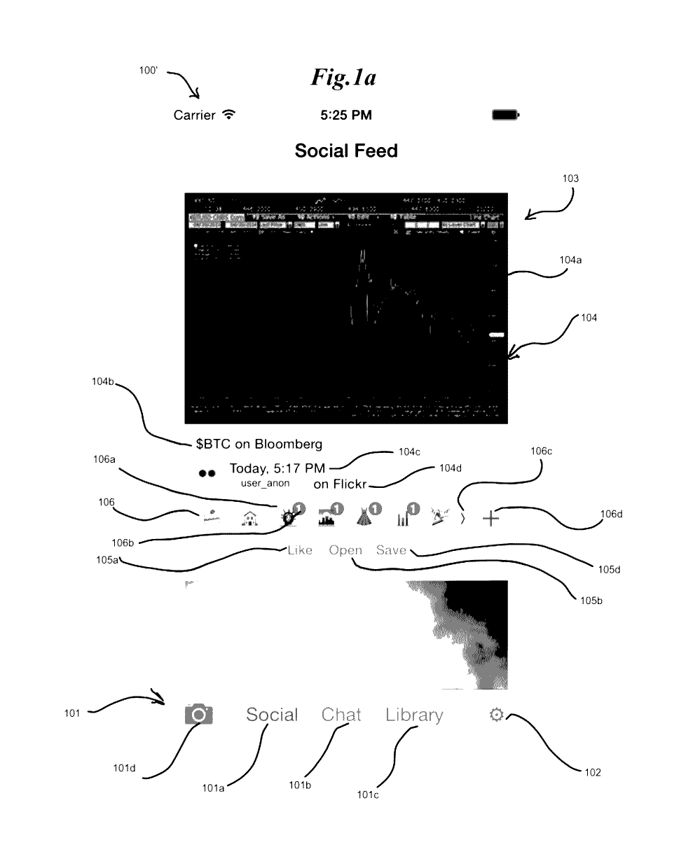

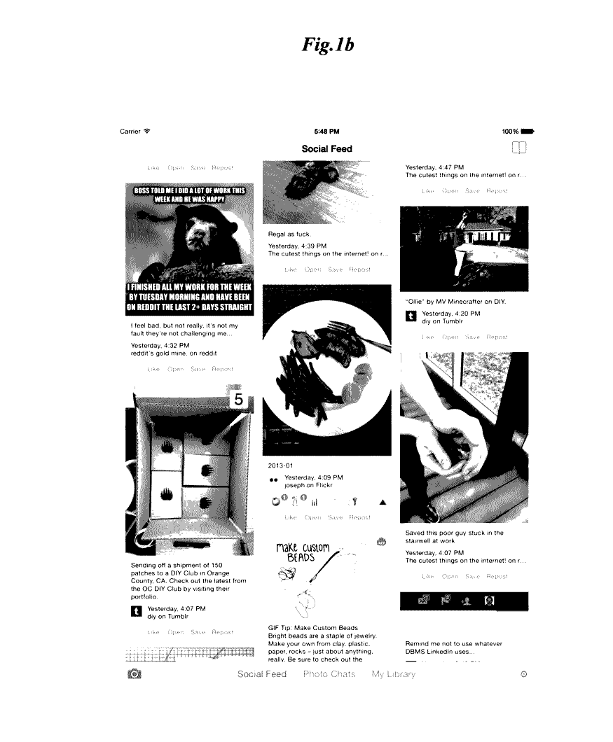

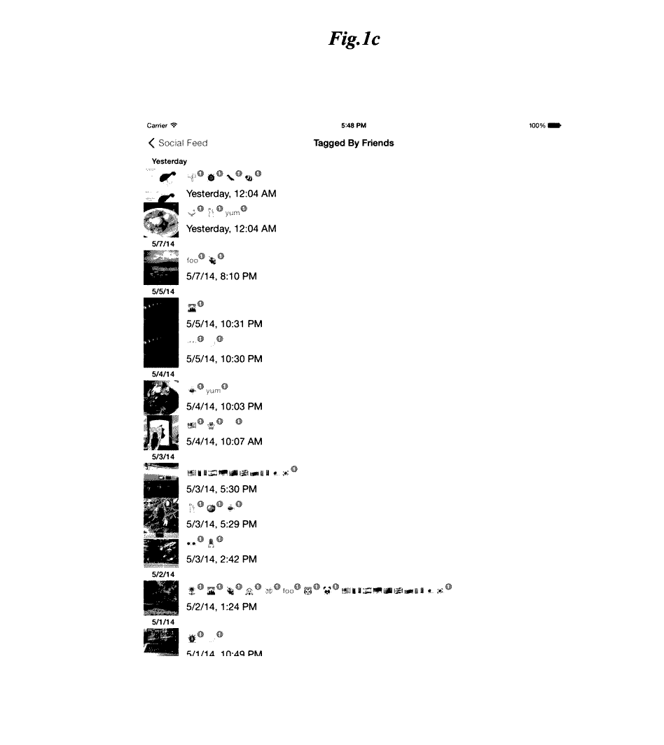

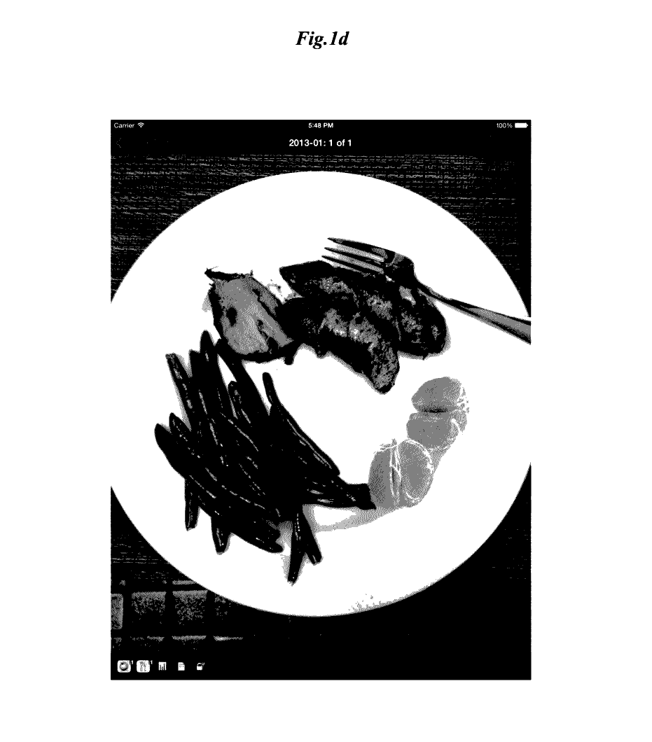

In one aspect of the present invention, a computer application (app) may be utilized to access and view the files and/or documents accessible to a user that may reside on multiple cloud services in a single unified app interface, which may be desirable as it would not require the user to log in or access each individual cloud service separately, each time. For example, the app may allow the user to enter the log in or access information at a setup stage and from then on the app would provide access to the user without further direct interaction between the user and the particular cloud service. The app may generally be utilized on any appropriate device, which may include, but is not limited to, a smartphone, a tablet computer, a personal computer, and/or any other appropriate computing device. In general, the app may employ a graphical user interface (GUI) and depending on the device, it may be accessible with a touchscreen interface and/or a keyboard/mouse interface, whichever may be appropriate, as illustrated with the different views in the GUI shown in FIGS. 1-7. The app may also employ other forms of interface, such as those designed for use with visually and/or hearing impaired users, and/or alternative interfaces, which may include, for example, voice recognition and/or playback, Braille computer interfaces, haptic interfaces, and/or any other appropriate interface. The app may also display any local files and/or documents on the particular device on which the user is viewing the app. The accessible files and/or documents of the user may be presented in a listing and/or graphical display. The agglomeration of all of the accessible files and/or documents of the user available in the app may generally represent a library of files and/or documents. In some embodiments, the app may access the cloud services through a proper application programming interface (API) for each particular cloud service, and may display all of the accessible files and/or documents to the user within the app. In some embodiments, the app may access the files and/or documents on the cloud services, but may generally not modify, permanently download, or move any of the files and/or documents from the cloud service on which they reside. Thus, the files and/or documents may also be used normally from the cloud service on which they reside without being affected by the app. In other embodiments, the app may have some ability to manipulate the files and/or documents stored on a cloud service, such as moving between services, deleting, copying between services, managing duplicates/versions/similar files and/or documents, editing, and/or any other appropriate or allowed manipulations, as such may depend on what is allowed by the API of the cloud service.

In some embodiments, the app may be utilized by a user for management of files and/or documents on various public cloud storage, cloud social media services, such as, for example, Facebook, Instagram, Twitter, Dropbox, Flickr, Google Drive, Box, OneDrive, cloud collaboration services, and/or any other appropriate cloud service. This may be desirable as the social media services, collaboration services, and cloud storage space are used for different purposes and are highly segmented, which may generally result in a user needing access to many different cloud services. The app may also include features to manage already extant organizational tools and/or schemes employed by the cloud service and/or storage, such as, for example, albums, folders, collections, marks, tags, hashtags, geotags, and/or other organizational methods. The app may, for example, provide features for syncing of similar and/or identical organizational tools and/or schemes, such as, for example, albums, folders, collections, marks, tags, hashtags, geotags, and/or other commonly employed organizational methods which may largely function similarly. This may be desirable as the user may then perform an organizational task once in the app and then have it mirrored in any of the appropriate cloud services. It may further be desirable as the user may also employ the app to apply an organizational scheme from one cloud service to another cloud service, or elsewhere, via the app.

In other embodiments, the app may be utilized by a user for management of files and/or documents on private cloud services and/or private servers. For example, some professionals may utilize a variety of privately hosted information resources, such as private company servers and/or servers of clients/customers. This may be desirable as different companies and/or clients/customers may utilize different hosted information sources/servers, and/or may wish to maintain overall control of files and/or documents without disseminating them over unsecure channels.

In another aspect of the present invention, the app may include systems and features for providing organization of files and/or documents, such as, for example, by marking files and/or documents with metadata which may contain semantic information. In some embodiments, the metadata generated through the app may be stored locally on the particular device the user is employing and/or the metadata may be stored on a remote server and/or cloud service. For example, the provider of the app may also host a server and/or cloud service to facilitate storage of metadata from the various users of the app. In some embodiments, the metadata may generally not be stored with the actual file on the cloud service on which it resides, but may be stored separately. However, the metadata may still be accessible to the user on any device the user employs the app through access to the remote server and/or cloud service for storing the metadata. In other embodiments, the metadata may be stored at, synced with and/or harvested from the cloud service where the file and/or document originated.

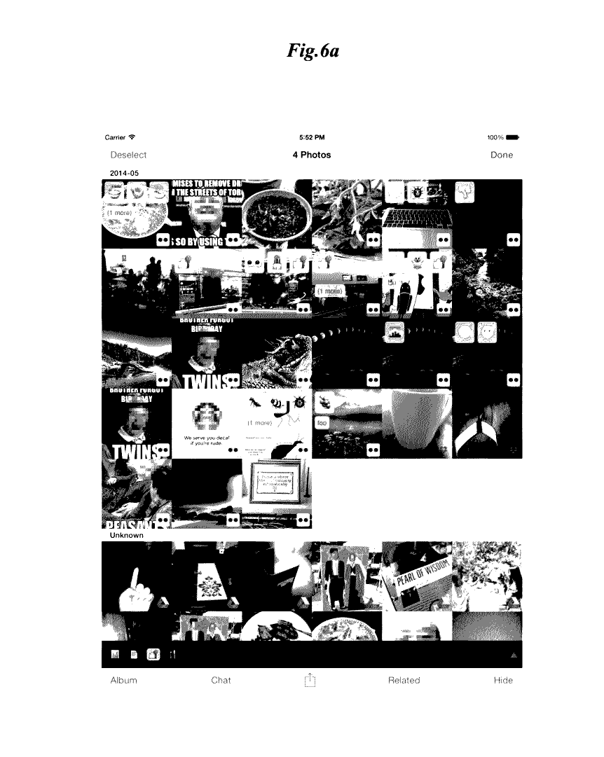

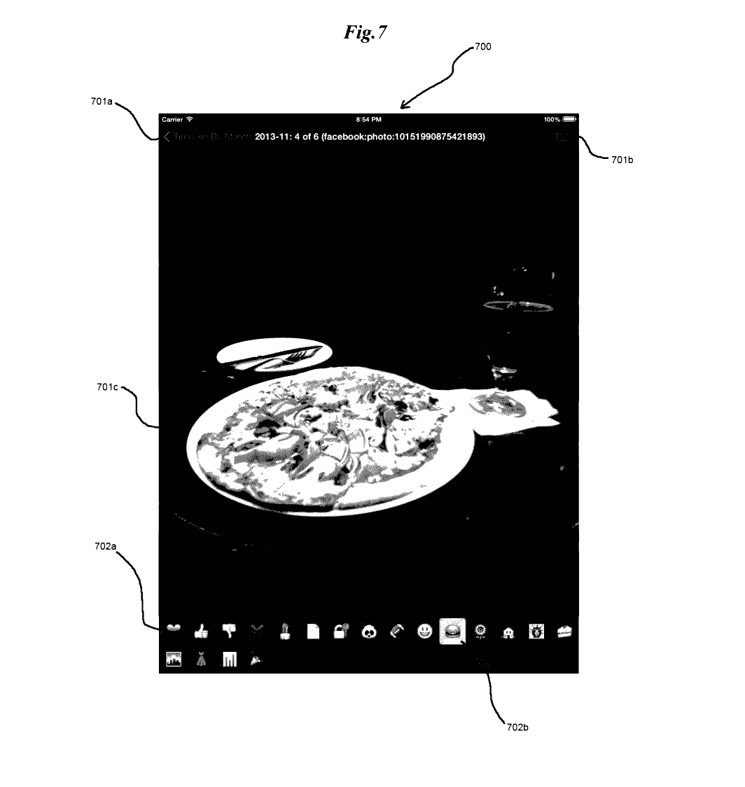

In some exemplary embodiments, the metadata may include a mark, such as, for example, a label, “sticker” or “tag” which may identify the file and/or document as part of a particular subset or category of items. Exemplary embodiments of marking files and/or documents are illustrated in FIG. 6 with the marking of photos 602 with tags using tag buttons 603e, and FIG. 7 with the marking of a single image 701c with tag buttons 702a. Marking may also be accomplished directly from a social media feed view in the app, as illustrated in FIG. 1a and as further discussed below. For example, in the context of managing photos or pictures, a tag (or multiple marks) may be utilized to identify the subject matter and/or other significance of a photo or picture. In some exemplary embodiments, the mark may include a graphical and/or illustrative symbol, such as an emoticon, emoji, smiley or similar types of graphical and/or illustrative symbols, which may provide a user with an intuitive way to associate files and/or documents with associative informations, such as a particular subject matter and/or other significance, such as the icons shown as tag buttons 603e and 701c in FIGS. 6 and 7, respectively. The mark may also include, for further example, animations, and/or marks that may be exchanged, bought, sold, bartered, and/or earned from other users, vendors, and/or other entities. For example, a mark may be utilized to assign emotional and/or social significance, such as like, dislike, appreciation, shock, surprise and/or any other appropriate significance. The marks may also be utilized as an alternative method of communicating information about a file and/or document that does not require normal linguistic communication, and may rather be used as a form of graphical “shorthand”. Additionally, the marks may be utilized in an organizational manner along with their communicative value.

In some embodiments, the marks may also represent a new or novel language created for and to be used amongst a group of users for communicating with each other, such as, for example, via a special code, a secret code, an industry/field specific taxonomy, local vernacular/dialect, and/or other appropriate communication format.

In general, marking may also include deleting, retracting, suggesting a deletion and/or suggesting a retraction of a mark in addition to a positive addition and/or suggestion of addition of a mark. The mark may also be a positive or negative value. For example, a mark may indicate or “tag” in a photo the presence of a person or a mark may also indicate that a person is not present (definitively, rather than just not already “tagged”).

The marks may exist as a preset list in the app and may be augmented and/or modified by the user. Once marked, files and/or documents may be sorted, searched and/or viewed by mark in the app to, for example, allow the user to easily find particular files and/or documents of a particular significance easily without sifting through the files and/or documents en masse. The app may further include features for marking multiple files and/or documents with a given mark without accessing each individual file and/or document. This may be desirable as the visual cues and graphically-oriented organization of files and/or documents may be more desirable to at least some users over more traditional approaches to file and/or document organization.

In some embodiments, the app may also automatically detect appropriate marks and/or mark based on associated information with a file and/or document originating from a social network service and/or cloud service. For example, the app may employ image recognition to determine subject matter and/or people in pictures to apply appropriate marks. The app may also, for example, utilize other information readily stored on the social network service and/or cloud service, such as the service's own version of tagging, hashtagging, geotagging, marking and/or other information association.

FIGS. 6 and 7 illustrate a set of marks in the icons used as tag buttons 603c, 702a for use with photos and/or images which may include common and/or general use tags, such as, for example, love, like, dislike, hate, fashion, text content, private, cute, sports, happiness, food, nature, home, landmarks, desserts, landscapes, clothing, statistics, information, and/or celebration. The app may also include features to allow users to add new marks and/or tags, display tags placed by other users, rearrange the order of the tags such as automatically (e.g. bringing tags placed by others to the front of the list), and/or any other appropriate customization.

Marks may also be employed at the onset of creation of a file and/or document, rather than being added after the fact. For example, the app may include a feature for applying a mark and/or selecting a set of marks to be applied while creating multiple files and/or documents in succession for which the mark(s) should apply. For further example, a user may designate a mark and/or a set of marks to apply to a series of photos the user is about to take using the app. The app may then apply the mark(s) as the photos are taken instead of the user going back after the photos are taken to apply the marks. This may be desirable, for example, when creating files and/or documents in a particular situation where a mark or set of marks may generally apply to all of the files and/or documents being created, such as, for further example, when a user is taking a series of photos at a particular event or of a particular subject. In one embodiment, the app may interface with the file- and/or document-creating application or feature of a computing device, such as, for example, a camera, document creating/editing application, information capture device, and/or any other appropriate application or feature. The setting of a mark and/or set of marks to apply while creating may then be chosen directly with the application or feature. In one example, the camera function of a computing device may include a plugin and/or other interface which enables a user to select a mark(s) to apply for the photos about to be taken.

In general, marking of files and/or documents, along with other information associated with the files and/or documents, may be utilized to generate filtered views of the available files and/or documents to be displayed to the user. Other information about the files and/or documents may include, for example, the source, date(s) associated, size, file type, marks, and/or any other appropriate information. For example, a user may utilize the app to filter files and/or documents and show only those from a particular set of cloud services having certain marks.

In other exemplary embodiment, the metadata may include a mark which may identify the file and/or document as part of a particular subset or category of items with different assigned weight(s) and/or significance(s). Any user may organize the files by assigning different or same weight(s) and/or kind or level of significance(s) to the files without disturbing the original file or document, to generate his/her own, for example, decision tree or presentation. In another example, a user may assign weight(s) and/or kind or level of significance(s) to particular marks which may indicate how the user values certain types of information about a file and/or document.

In a further aspect of the present invention, the app may include features for displaying an agglomeration of files, documents and/or social media postings collected from the multiple cloud services of a user. This may generally enable the user to view an up-to-date and/or near real-time feed of updates occurring on the various multiple cloud services. In some embodiments, the app may include a social media feed which may display posts and/or updates from the social media services the user employs, such as, for example, Facebook®, Twitter®, Instagram®, Google+®, and/or any other appropriate social media service, such as illustrated with the social media feed mode of UI 100 in FIGS. 1 and 1a. The app may further update the feed at intervals and may keep the feed up-to-date in near real time and/or real time. The app may also include features for customizing the update interval to a desired timing, and/or features for customizing the filtering tools, such as to see relevant subsets of files, documents and/or other information.

In some embodiments, the feed may contain updates, posts and/or files from multiple social media services, and/or a selection thereof. Some social media services may provide posts and/or files from other users, which may be displayed in the app. The app may also include features for saving the posts, links, links to files, and/or files from other users into the library available in the app. The app may also provide accessibility to social media interaction, such as “liking”, “commenting”, “sharing”, and/or any other appropriate interaction, depending on the applicable social media service, as illustrated with the user actionable items 105a, 105b, 105c, 105d for a given social media feed item 104 in FIGS. 1 and 1a. The app may also include features to allow the user to mark items directly in the social media feed mode, as illustrated in FIG. 1a.

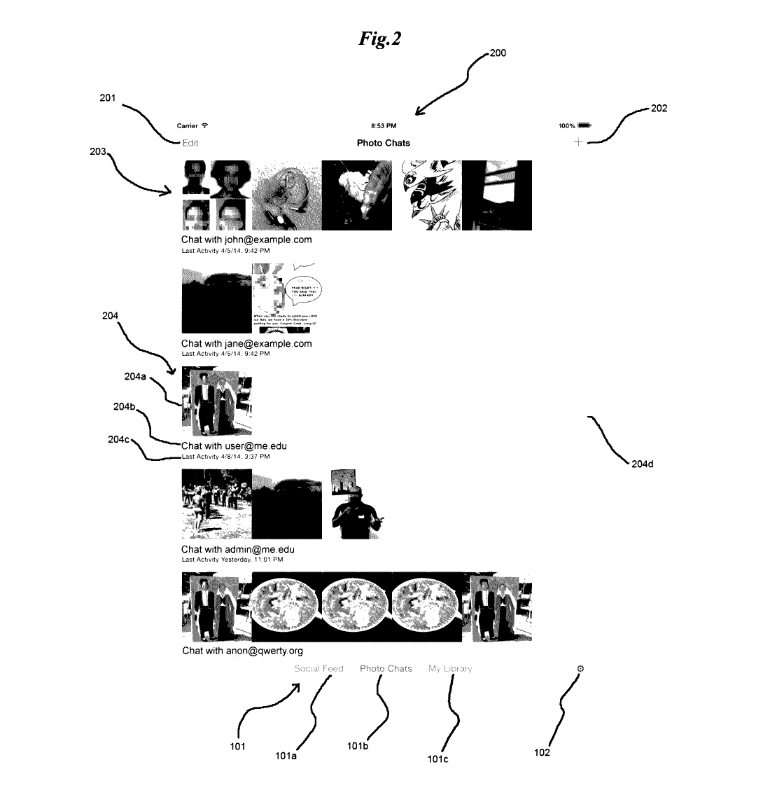

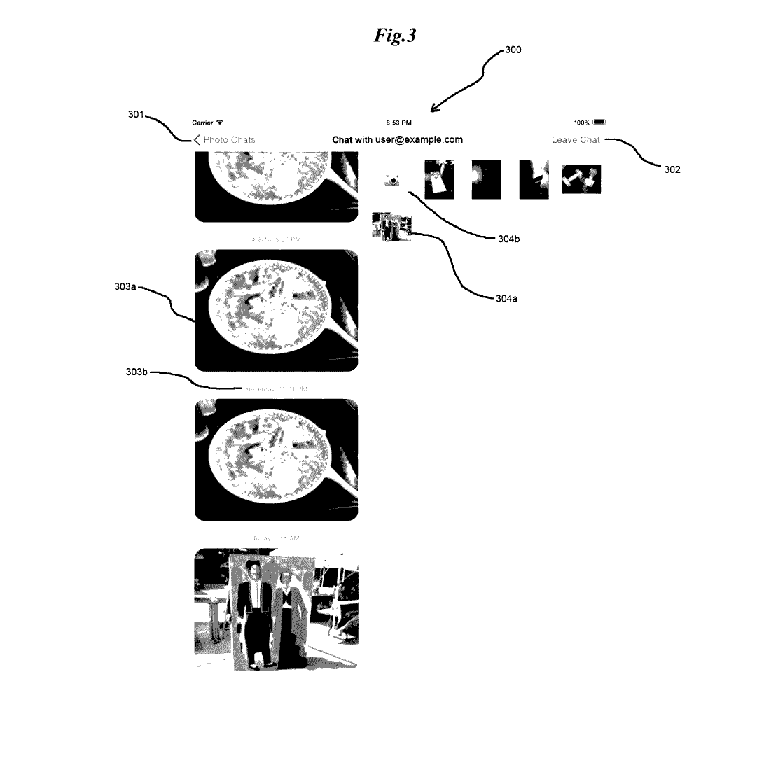

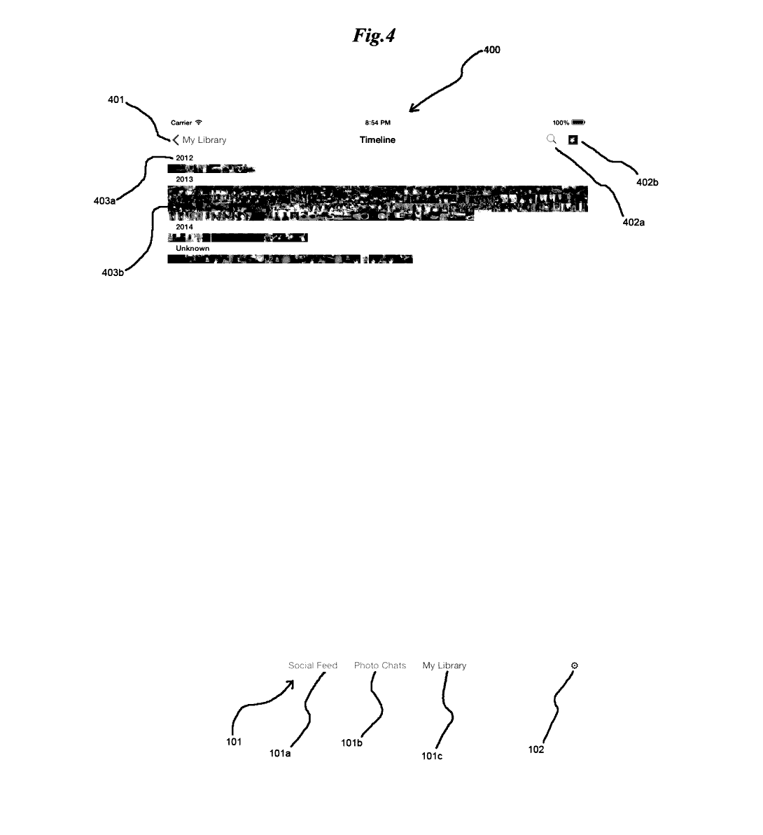

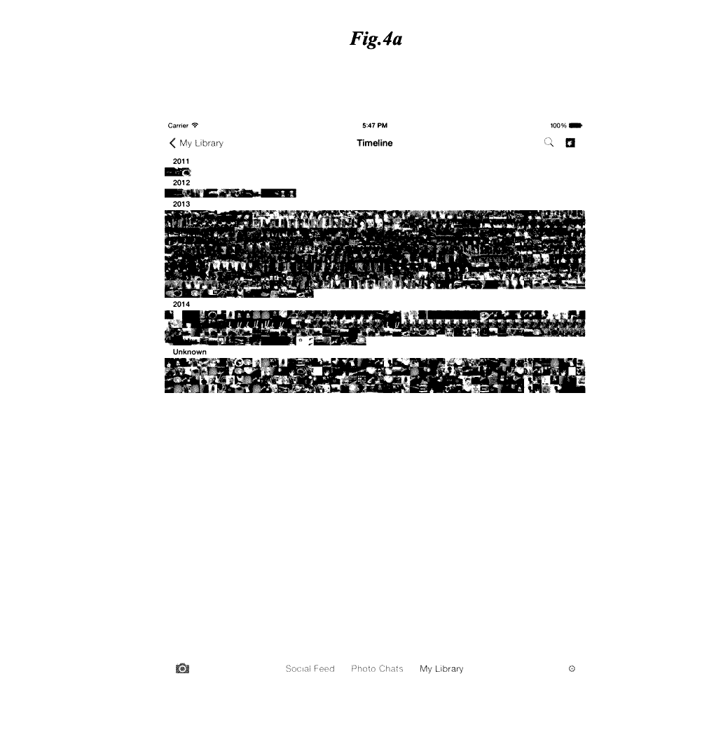

In still another aspect of the present invention, the app may include systems and features for sharing files and/or documents with other users. In some embodiments, the app may include a messaging and/or chat interface which may enable a user to communicate with another user of the app, and may also enable a user to share files and/or documents with another user of the app, as illustrated with the photo chats in FIGS. 2 and 3. In some embodiments, the app may also enable the user to share files and/or documents with others who are not employing the app, such as, for example, providing a direct link to the file and/or document and/or the folder(s) or location(s) containing the file and/or document via e-mail and/or other appropriate message. Other information may also be exchanged, such as the marks associated with the file and/or document, as discussed above, which may be shared automatically or manually. New files and/or documents may also be created in the context of the communication, such as, for example, creating a file and/or document during the course of the communication, such as taking a photo, as opposed to, for example, only working with files and/or documents created prior to the start of the communication exchange. In general, the communication may occur in real time and/or near real time, such that users of the app may act as if files and/or documents created by any user in the communication may be immediately accessible to everyone in the communication, including any associated information, such as marks, as discussed above. Transfers (i.e., file copies) may also be accomplished with the app across different cloud services, and may be done automatically when needed to, for example, enable multiple users to see the files and/or documents, even if there are pairs of users in the communication that may not share common cloud services. For example, one user may be utilizing a first cloud service and a second user may be utilizing a second cloud service, where the users do not use a common cloud service. The app may then facilitate transfer from the first cloud service to the second and/or vice versa to accommodate the users not using the same cloud services. This may be desirable as users may have the flexibility to retain copies and/or links in their libraries to information exchanged through a communication session.

In general, many users of smartphones and other mobile devices are subject to data plans for internet access which may include limits on bandwidth and/or data transfer. It may thus be desirable for a sharing function of the app to include features for limiting the use of a mobile device's data plan while optimizing use on unlimited and/or less limited connections to the internet, such as, for example, WiFi hotspots, home or office internet connections and/or any other available internet access for which there are fewer or no data transfer restrictions. In some embodiments, the app may share a preview, a thumbnail, a portion of, and/or any other appropriate abbreviated version of a file and/or document in a message and/or chat to another user while the user is on a limited data connection. The user may elect to view the entire file and/or document while on the limited data connection, or the user may also wait to view the entire file and/or document while on an unlimited and/or less restricted internet connection. The app may also, for example, queue up operations to be performed when the user is on an unlimited and/or less restricted internet connection, and execute the queued up operations on behalf of the user when an unlimited and/or less restricted internet connection is detected. This may be desirable as it may allow users to perform actions at their convenience, such as when they are on a limited data connection, without having to remember to execute the operations later when they are on an unlimited and/or less restricted internet connection.

In some exemplary embodiments, a user may interact with the files and/or documents of another user via a social network and/or cloud service in the same manner as the user's own files and/or documents. For example, the app may include features for allowing a user to mark, such as described above, the files and/or documents of another user. In general, marking may also include deleting, retracting, suggesting a mark be added, suggesting a mark be absent, and/or retracting a suggestion about the presence of a mark. This may be desirable, for example, to enable social interaction between users via marking each other's files and/or documents. For further example, users may assist each other in marking files and/or documents. This may, for example, be used to distribute the management and/or organizational load among many users. There may also be a social interaction value, as some users may be more inclined to organize and mark files and/or documents than others. Different users may also associate different information with files and/or documents. For example, a photo may have a particular significance to one user, but it may have a different significance to another user. The app may thus allow the multiple users to mark the photo accordingly. Also, some users may notice information about a file and/or document that other users may not, and thus the additional information may be utilized with multiple users. For example, a user may not notice the presence of an item of interest in a photo, but another user may notice and mark the photo accordingly. The app may further include features for resolving conflicts between the markings made by different users, such as discussed further below. The app may also include features for tracking multiple users marking a file and/or document in the same way or with the same mark, which may be used, for example, to weight or value the confidence of a mark, or, for further example, as a voting mechanism for whether a given mark should apply to a given file and/or document, such as by gauging popularity by the number of votes for a particular mark. The marks may also be propagated back from the app to the social network and/or cloud service where the file and/or document originated. The back propagation may be controlled by the user and/or through a setting and/or control in the app such that the distribution of the marking information may be limited, such as, for example, for privacy control of the marking information.

In some embodiments, the cooperative marking of files and/or documents may also be associated with a social interaction activity and/or game. For example, a user may be awarded some value for marking the files and/or documents of others in a positive manner.

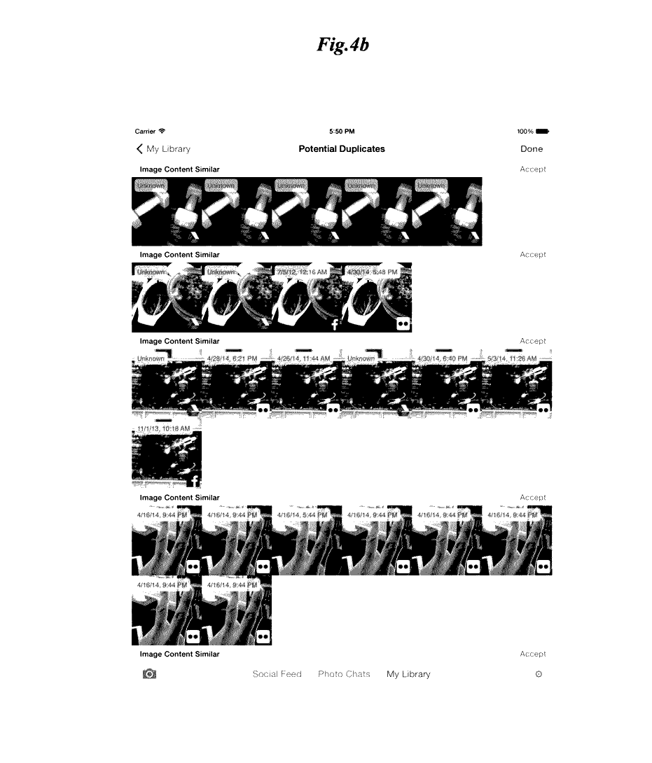

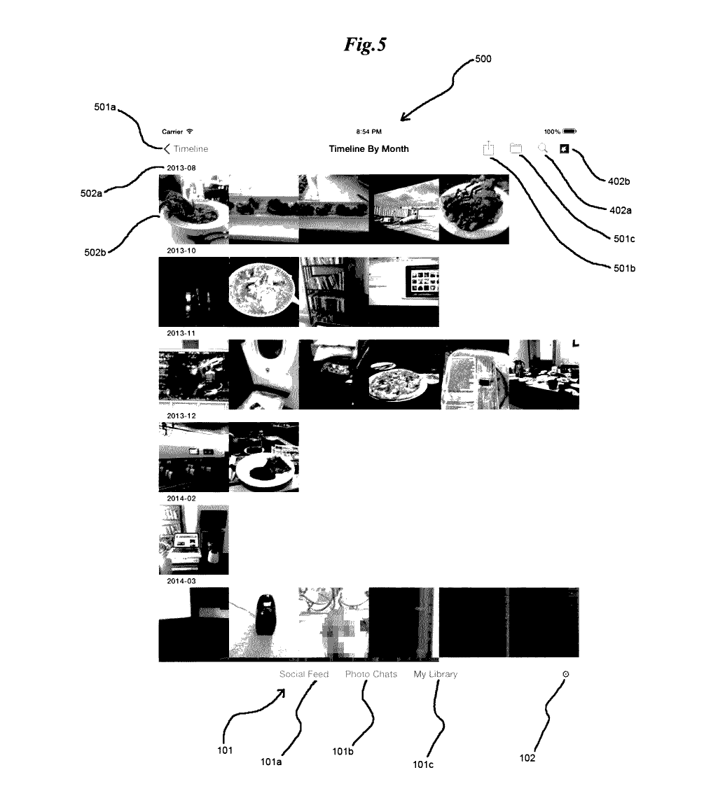

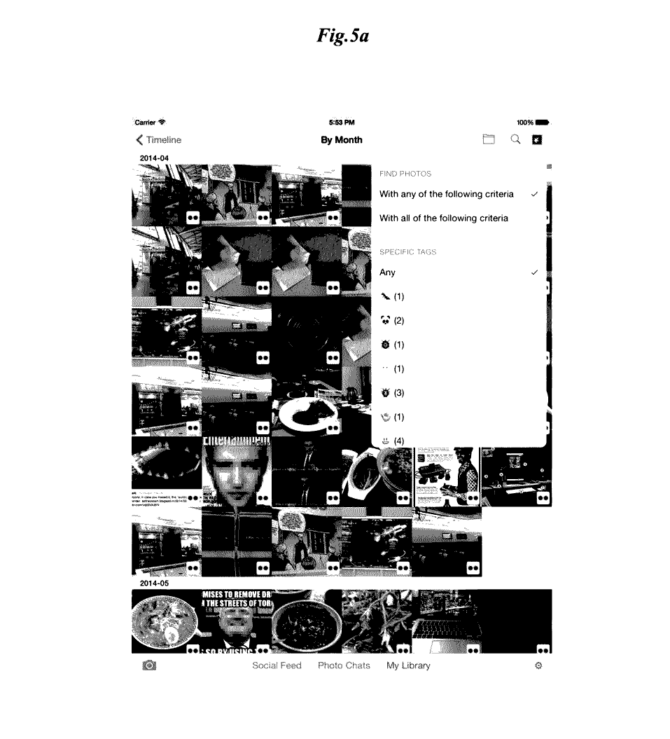

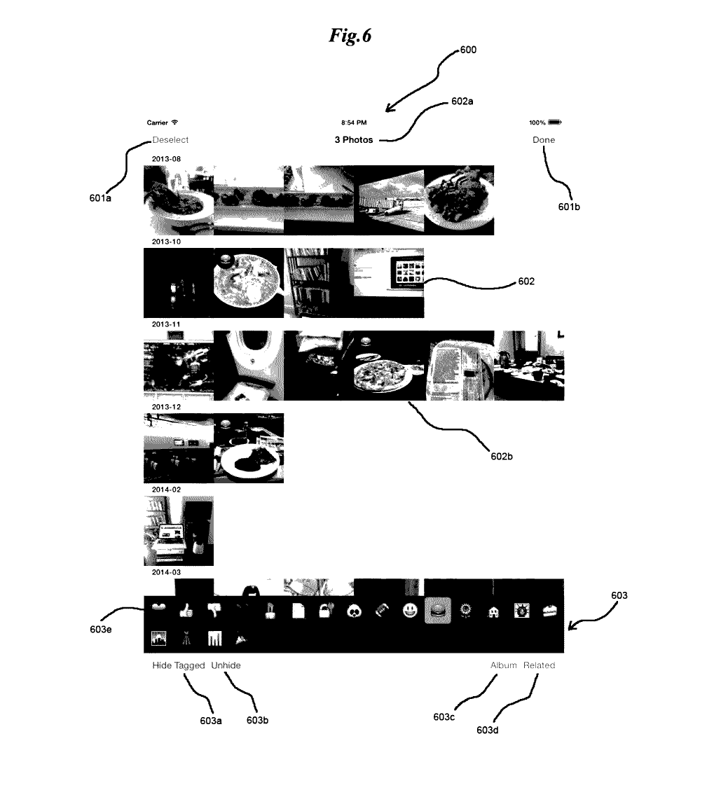

In yet another aspect of the present invention, the app may include features for enabling a user to review and/or recollect information stored within the files and/or documents accessed by the app. FIGS. 4 and 5 illustrate embodiments of the app displaying photos organized in a timeline fashion by year in FIG. 4 and by month in FIG. 5. In some embodiments, the app may be utilized to recall a selection of information from the past activities of a user, such as, for example, recalling a selection of social media posts and/or images. The app may also be utilized to recall a selection of information based on filtering for marks and/or other organizational information. In another example, the app may display a selection of images in a visually appealing manner, such as, for example, in the form of a slideshow, moving picture tiles and/or any other appropriate display of images, which may appear in a two-dimensional format, a simulated three-dimensional format, and/or a combination of both. The app may thus also be used to allow a user to reminisce over information from the past in a visually appealing way. This may also be desirable to share such information with others by presenting it to them from the app in a visually appealing way rather than, for example, in a more structured manner, such as with a file folder hierarchy and/or other less aesthetically pleasing display. The app may also track the viewing and/or usage of files and/or documents by the user to make determinations about how to display information for reminiscing, such as, for example, how often and how recently such information has been viewed.

In still another aspect of the present invention, the app may include systems and features for detecting and managing duplicates and/or versions of files, documents and/or other information, as well as detecting and managing files, documents, and/or other information that may be similar. In general, duplicates and/or versions of files, documents and/or other information may exist relatively unintentionally as a result of using multiple social networking services and/or cloud services to keep and/or disseminate information, such as, for example, by posting a photo to multiple different social networks. Duplicates and/or versions of files, documents and/or other information may also exist for the purpose of backing up the files, documents and/or other information.

In one embodiment, multiple copies and/or versions of a particular file, document and/or information may be present on multiple cloud services and/or social networks employed by a user. The app may generally detect similarity and may further, for example, group such similar files, documents, and/or information together within the app. This may be desirable such that the user may better manage information without being faced with duplicates and/or versions displayed in multiplicity. The app may also, for example, include features for managing duplicates and/or versions. For example, the app may enable the user to show/hide duplicates and/or versions, show statistics for levels of duplication and/or versioning, detect the quality, truncation and/or completeness of a duplicate and/or version, intentionally create duplicates for backup purposes or for publishing/dissemination, allow the user to determine if duplication actually exists between candidates the app has detected, cloning of organizational and/or marking information across duplicates and/or versions, and/or any other appropriate management operations. The app may also, for further example, collect and/or display associated information about the various duplicates and/or versions from their various sources. For example, in a social media context, the app may collect comments, “likes”, “tags”, “hashtags”, “geotags”, and/or other information associated with duplicates and/or versions of a file, document, and/or other information from varied sources and coalesce them into one set of associated information for the user to view and manage. This may be desirable, for example, to allow the user to more easily collect and process feedback for a single piece of information from varied social networks and/or cloud services by associating them together. The coalesced associated information may also be utilized by the app to affect marking within the app, as discussed above.

In some embodiments, the app may also allow a file, document and/or other information to be disseminated across various social networks and/or cloud services by creating multiple duplicates and/or versions to upload and/or post. For example, the app may post and/or upload a single original file, document and/or other information to multiple cloud services to create the multiple duplicates and/or versions spread among the multiple cloud services. The app may further track these duplicates and/or versions from their initial creation to collect and/or coalesce associated information from the duplicates and/or versions as they arise. This form of purposeful and/or intentional dissemination of duplicates and/or versions may thus be utilized to reach more audience while retaining agglomeration of any associated information, such as comments, feedback, likes”, “tags”, “hashtags”, “geotags”, and/or other information associated with duplicates and/or versions.

In some embodiments, the app may also automatically disseminate duplicates and/or versions based on particular settings, such as, for example, based on marking of a file, document and/or other information. The user may further determine rules and/or situations where automatic dissemination should occur and to what social media services and/or cloud services the dissemination should include. The app may also automatically detect when such dissemination should occur and may also prompt the user to allow such automatic dissemination. For example, if the app detects the addition of files, documents and/or other information which is normally disseminated, the app may prompt the user to allow automatic dissemination.

In yet another aspect of the present invention, the app may include systems and features for creating and storing of a compilation of files contributed by various users at various times from same or different devices in one or multiple private and/or public clouds. In one embodiment, the compilation may be manipulated and organized, for example, by a designated user(s) to generate a presentation to be accessed and viewed simultaneously by invited users. In another embodiment, the compilation may be manipulated and organized, for example, by any user to generate a presentation or booklet to be accessed and viewed simultaneously by invited users without disturbing the original compilation.

In yet a further aspect of the present invention, the app may include systems and features for automatically storing of files that have been marked for a particular location in that location or marked with a weight, or a kind or level of significance in the location with the particular significance. A user or multiple users may cooperatively work on or create files simultaneously or at different times.

In some aspects of the present invention, the app may include features for managing attributes, properties and/or other metadata about the files and/or documents in the library, which may include, but are not limited to, associated dates, content, physical locations, subject matter, comments, feedback, associated information, such as the marks discussed above, including emoji, smileys, “likes”, “tags”, “hashtags” and/or “geotags”, and/or any other appropriate information. The app may also include features for correcting errors, adjusting consistency between potential duplicates and/or versions, inputting missing information, and/or importing/exporting metadata between the app, cloud services, social networking services and/or any combination thereof.

In one aspect of the invention, the app may store and handle metadata, such as the types discussed above, about the files and/or documents in the library by being configured to organize, assess, and/or apply different types of logical assertions made by an agent about a file and/or document accessed by the app. The assertions may thus function within the app as representations of the underlying metadata the assertions describe. The agent may be a hosting service, a social network, a part, entirety, or any combination thereof of the app itself, the user, another user, such as discussed above in regards to multiple users performing marking, and/or any other appropriate entity providing information about the file and/or document. These assertions may then, for example, be utilized by the app to enable and/or govern organizational behavior in the app, such as with the marking and/or duplicate/versioning handling, as discussed above.

In general, the assertion may include information about the file and/or document which may be accessible by the app, which may further be used by the app to make determinations of attributes of the file and/or document, depending on the property of interest of the file and/or document, the value of the said property, and/or the mode of assertion being made. The assertion may also include information about other forms of information, such as the marks used in the app, other data, abstract information, indications of duplication/versioning, and/or any other appropriate information for which an assertion may be made. Assertions about other forms of information may generally function in a similar and/or identical fashion to assertions about files and/or documents, as discussed below. The underlying metadata may generally be stored in the form of assertions representing the metadata, which may themselves be stored locally on the particular device the user is employing and/or the assertions may be stored on a remote server and/or cloud service. For example, the provider of the app may also host a server and/or cloud service to facilitate storage of assertions representing metadata from the various users of the app, such as in a database or data structure. In some embodiments, the assertions about a file may generally not be stored with the actual file on the cloud service on which it resides, but may be stored separately. However, the assertions may still be accessible to the user on any device the user employs the app through access to the remote server and/or cloud service for storing the assertions. In other embodiments, the assertions may be stored at, synced with and/or harvested from the cloud service where the file and/or document originated, such as by utilizing an available storage mechanism of the cloud service.

In some embodiments, the assertion may be a property assertion and assert a property of a file and/or document that has a singular value. This assertion may include information about the agent, file and/or document being accessed, property of said file and/or document, value of the said property, timestamp of when the assertion was recorded, timestamp of when the assertion was made (i.e. when the assertion became true and/or took effect), physical location of the agent when the assertion was recorded, physical location of the agent when the assertion was made and/or any other relevant attributes. Property assertions may, for example, generally be utilized for marking and/or to govern how marks are applied, as discussed above.

In some embodiments, the assertion may be a multiple property assertion and assert a property of the file and/or document that has multiple values. This assertion may include information about the agent, file and/or document being accessed, property of said file, file and/or document being accessed, property of said file and/or document, value of the said property, timestamp of when the assertion was recorded, timestamp of when the assertion was made (i.e. when the assertion became true and/or took effect), physical location of the agent when the assertion was recorded, physical location of the agent when the assertion was made, order of the file and/or document in relation to other files and/or documents that are also values of the same property, and/or any other relevant attributes. Multiple property assertions may, for example, generally be utilized for marking and/or to govern how marks are applied, as discussed above.

In addition, if desired, the multiple property assertions may also include location specificities such as for example, where the file was created, marked or viewed, potentially allowing location tracking of a user.

In some embodiments, the assertion may be called equivalence assertion and assert that more than one file and/or document accessed by the app are the same, equivalent and/or similar enough to warrant association. This assertion may include information about the agent, file and/or document being accessed, equivalence class, second file and/or document that is equivalent, timestamp of when the assertion was recorded, timestamp of when the assertion was made (i.e. when the assertion became true and/or took effect), physical location of the agent when the assertion was recorded, physical location of the agent when the assertion was made, and/or any other relevant attributes. Equivalence assertions may, for example, be utilized for assessing and/or governing the handling of duplicates, versions and/or other similarities between multiple files, documents and/or other types of information, as discussed above.

In some embodiments, an assertion may carry Boolean values which identify the mode of assertion being made by an agent. For example, an assertion may carry a Boolean value for whether the assertion is retracting a previous assertion. This may be desirable as the retracting assertion may delete the previous assertion being retracted, while preserving the information contained about the previous assertion, thus allowing historical tracking of assertions made against a file and/or document in the app. In another example, an assertion may carry a Boolean value for whether the assertion being made is a positive assertion or a negative assertion, such as, for further example, asserting whether a particular property and/or value is present or not present. For further example, in one embodiment, an assertion may be made about a photo where an agent asserts that a particular person is in the photo, which would be a positive assertion of a property and/or value. Another assertion may assert that another person is not in the photo, which would be a negative assertion of a property and/or value. This may be desirable, for example, as such an assertion is unambiguous as compared to a deduction that a person is not in the photo simply due to the lack or absence of an assertion that the person is in the photo.

In another aspect of the invention, the app may be configured to provide for the capability to carry out a multi-way synchronization of files and/or documents. For example, the app may combine the assertions from different sources, devices, services and/or users together.

In some embodiments, the app may also be configured to allow for information to be manipulated in the app while the app is disconnected from a social network, cloud service and/or the internet, such that the user may utilize the app while not connected. For example, the app may be utilized in this manner while the user is in an internet deadzone, while traveling where internet connections and/or service connections are limited, restricted and/or unavailable, onboard an aircraft, and/or any other situation where connectivity is limited, restricted and/or unavailable. The app may then synchronize with the social network, cloud service and/or service for syncing and/or storing metadata when the user returns to connectivity.

In some embodiments, the app may generally include well-defined semantics regardless of concurrent modifications, such as, for example, by providing rules and/or hierarchy for dealing with agent priority in making changes and/or assertions, such that any conflicts may be resolved by the app. For another example, the app may combine and/or add assertions from various sources together. In another example, the user and/or the last modification and/or assertion in time may have priority over others. In a further example, multiple property assertions may be made by different parties and/or in different places, which may then be merged with minimal and/or no ambiguity or conflict as the multiple property assertions may inherently provide for multiple values even from different sources and/or locations.

In some embodiments, the app may generally include an ability to backtrack to see why a certain property is recorded a certain way, such as with the history stored with retractions, as above. In another example, the app may display a reasoning chain and/or inference(s) of why a property is recorded in a certain way. For example, with a photo taken on a first date, modified on a second date, and posted on a third date, the app may infer that the proper date for organization purposes is the second date, based on an inference that the modification date has priority over the taken date and/or the posted date. This may be employed, for example, with a plurality of property value assertions to discriminate various timestamps.

In some embodiments, the app may generally include support for multiple trust levels so that properties asserted by agents of lower trust levels can be overridden by the user, which is an agent of the highest trust, even if an agent of lower trust asserts the property again.

In general, the app may also include features for notifying the user of changes to files, documents and/or other information within the app, such as, for example, addition/changes/deletions/retractions of marks, chats, detection of duplication, requests for interaction from other users, and/or any other appropriate notification.

### Example of a Social Media Feed

FIG. 1 illustrates an exemplary user interface (UI) arrangement of social media feed mode. UI 100 may include a list of mode indicators 101, an app settings button 102, and an ordered list 103 of individual social feed updates 104. The mode indicators 101 may allow the user to know which mode the user is engaged in, which may include social feed 101a, photo chats 101b, and/or library 101c. The social media feed mode as illustrated in FIG. 1 may aggregate different social feed updates 104 from different services, such as Facebook®, Twitter®, Instagram® and others, and display them in an ordered list 103. Each social feed update may include a thumbnail of relevant image 104a, an abbreviated version of accompanying text 104b, timestamp of when the feed item 104 was created 104c, and/or author/source of the feed item 104d. The social media feed may further include user actionable items such as to like 105a, which may allow others participating users to see that the user favors the content of said feed update, open 105b, which may allow the user to examine said feed in a greater detail by displaying the relevant image in greater magnification as well as an unabbreviated version of any accompanying text, open in another app 105c, which may allow another application on the device to display the item 104, and/or save 105d, which may allow the user to save the feed item 104 in an archive and/or in the library of the app. The app settings button 102 may allow the user to configure the way the app functions, such as any of the various customization and/or settings options discussed above. The item 104 may also include a repost button, which may be utilized to disseminate the item 104 to a social network and/or cloud service, as illustrated in FIG. 1b.

### Example of a Social Media Feed

FIG. 1a illustrates an exemplary user interface (UI) arrangement of social media feed mode. UI 100′ may include a list of mode indicators 101, an app settings button 102, and an ordered list 103 of individual social feed updates 104. The mode indicators 101 may allow the user to know which mode the user is engaged in, which may include social feed 101a, photo chats 101b, library 101c, and/or camera 101d. The social media feed mode as illustrated in FIG. 1a may aggregate different social feed updates 104 from different services, such as Facebook®, Twitter®, Instagram® and others, and display them in an ordered list 103. Each social feed update may include a thumbnail of relevant image 104a, an abbreviated version of accompanying text 104b, timestamp of when the feed item 104 was created 104c, and/or author/source of the feed item 104d. The social media feed may further include user actionable items such as to like 105a, which may allow others participating users to see that the user favors the content of said feed update, open 105b, which may allow the user to examine said feed in a greater detail by displaying the relevant image in greater magnification as well as an unabbreviated version of any accompanying text, and/or save 105d, which may allow the user to save the feed item 104 in an archive and/or the library of the app. The feed item 104 may also include features for allowing marking of the feed item 104, such as with the tagging buttons 106 as illustrated. Tags which are already applied may also be indicated, such as with highlighted tags 106a. The highlighted tags 106a may also indicate the number of times or votes for the given tag, such as from different users and/or the user, as shown with number indicator 106b. Further tags may also be accessed through expansion button 106c. The feed item 104 may also include an add button 106d which may be used to add or create additional tags or to access additional options. The app settings button 102 may allow the user to configure the way the app functions, such as any of the various customization and/or settings options discussed above. The item 104 may also include a repost button, which may be utilized to disseminate the item 104 to a social network and/or cloud service, as illustrated in FIG. 1b. FIG. 1c illustrates a view with a subset of items from the social feed which are tagged by friends, while FIG. 1d illustrates a view of a single item from the social feed with associated tagging.

### Example of a Listing of Photo Chats

FIG. 2 illustrates an exemplary user interface (UI) arrangement of a listing of photo chats. Photo chats may generally allow two or more participating users to exchange images in a chat session. UI 200 may generally share the same list of function indicators 101 and app settings button 102 with UI 100 in FIG. 1. UI 200 may also include user actionable buttons such as edit button 201, which may allow the user to leave one or more photo chat sessions, and/or + button 202, which may allow the user to start a photo chat session with a desired recipient. Further, the UI 200 may include an ordered list 203 of one or more photo chat sessions 204, which may display thumbnails of images exchanged in the photo chat session 204a, the user(s) who is participating in the chat session 204b, timestamp/activity indicator 204c, and/or expansion arrow 204d, which may allow the user to enter the specific photo chat, as illustrated in FIG. 3.

### Example of a Photo Chat

FIG. 3 illustrates an exemplary user interface (UI) arrangement of a single photo chat session. UI 300 may generally include user actionable buttons such as return to photo chats button 301, which may allow the user to return to UI 200 as shown in FIG. 2, leave chat button 302, which may allow the user to stop participating in the current chat session, thumbnail of exchanged photo 303a, timestamp of said thumbnail 303b, images to be exchanged 304a (which may be changed or augmented), and/or option to use the device's camera to take a photo to be used in the chat session 304b. In general, the photo chat may be able to send any and/or all of the photos available in the library, such as individually, or en masse.

### Example of a Timeline View by Year of Photos in a Library

FIG. 4 illustrates an exemplary user interface (UI) arrangement of a timeline view of a library of photos, sorted by the year the photos were taken. UI 400 may generally share the same list of function indicators 101 and app settings button 102 with UI 100 in FIG. 1. UI 400 may also include user actionable buttons such as return to my library button 401, which may takes user back to the main library UI, search and/or filter button 402a, which may allow the user to search for a particular image of interest in the library or filter images based on criteria such as tags, and/or reminisce button 402b, which may start a slideshow and/or other graphical display of images in the library such as in a randomized manner, a year indicator of when the images were taken 403a, and/or an ordered list of thumbnails of the images in the photo library 403b. The UI 100 may also include a button for accessing a camera, as shown in FIG. 4a. FIG. 4b illustrates a subset of items from the library which may include duplicates and where the duplicates reside, as discussed above.

### Example of a Timeline View by Month of Photos in a Library

FIG. 5 illustrates an exemplary user interface (UI) arrangement of a timeline view of a library of photos, sorted by year and month the photos were taken. UI 500 may generally share the same list of function indicators 101 and app settings button 102 with UI 100 in FIG. 1. UI 500 may also include user actionable buttons such as return to timeline button 501a, which may take the user back to the timeline UI 400, upload button 501b, which may allow the user to upload and/or publish one or more photos, and/or tag button 501c, which may allow the user to tag one or more photos with a tag. The UI 500 may also share the search and/or filter button 402a and reminisce button 402b with UI 400. Further, UI 500 may also include a year and month indicator of when the images were taken 502a, and/or an ordered list of thumbnails of the images in the photo library 502b. FIG. 5a illustrates a view of the library of photos, sorted by year and month the photos were taken, and by specific criteria, as indicated by the tags selected in the dropdown menu.

### Example of a Photo Tagging Interface

FIG. 6 illustrates an exemplary user interface (UI) arrangement for photo tagging. In UI 600, the user may select one or more images and apply one or more tags to categorize them and/or apply to the images. UI 600 may also include user actionable buttons such as deselect button 601a, which may allow the user to remove all previously selected images, and/or done button 601b, which may allow the user to complete the tagging process. UI 600 may further include an image counter 602a, which may show the number of images currently selected, and/or selection marker 602b, which may show which image is currently selected. It may further include an arrangement of buttons 603, which may include “Hide Tagged” button 603a, which may remove images that are already tagged from view, “Unhide” button 603b, which may reverse the action of the “Hide Tagged” button 603a and makes visible previously hidden and tagged images, “Album” button 603c, which may allow the user to place selected images in an album of choice, “Related” button 603d, which may select other images that are deemed to be related to the selected image, and/or tag buttons 603e representing an array of different categories, feelings, attributes, values and/or information that may be applied to the selected image(s). FIG. 6a illustrates a view of photo tagging in a library of photos showing duplicates by source and tags already applied with a selection of most recently applied and/or suggested tags.

### Example of a Single Photo Tagging Interface

FIG. 7 illustrates an exemplary user interface (UI) arrangement of photo tagging of a single photo. UI 700 may display a single image 701c in a greater magnification than a thumbnail and may allow the user to tag it. UI 700 may also include user actionable buttons, such as “Timeline by month” button 701a, which may take the user back to timeline UI 500, and/or tag button 701b, which may allow the user to tag one or more photos with a tag(s). UI 700 may further include an array of tag buttons 702a, which may generally be the same as tag buttons 603e in FIG. 6, representing an array of different categories, feelings, attributes, values and/or information that may be applied to the selected image. For example, as illustrated in FIG. 7, an image 701c is that of a pizza, and tag button 702b is in a shape of a burger representing food category is selected.

It will be appreciated by those of ordinary skill in the art that the present invention can be embodied in other specific forms without departing from the spirit or essential character hereof. The present description is therefore considered in all respects to be illustrative and not restrictive. The scope of the present invention is indicated by the appended claims, and all changes that come within the meaning and range of equivalents thereof are intended to be embraced therein.

1. A method for marking information aggregated from across a plurality of computer storage facilities comprising:
providing a user interface (UI) on a computing device capable of creating, conveying or displaying at least one item of information;
providing a selection of marks which may be applied to said item of information, said selection of marks comprising identifying representations of different associative informations;
selecting at least one mark from said selection of marks which potentially describes said item of information to apply to said item of information; and
recording an association between said at least one mark and said item of information on said computing device;
wherein said association stores metadata describing said item of information with marking information about its associative information.

2. The method of claim 1, wherein said association is recorded in a consistent manner which disambiguates the origin, timing and priority of said metadata across a plurality of computing devices or cloud services to enable resolution of conflicting information and agglomeration of non-conflicting information using an assertion selected from the group consisting of property assertions, multiple property assertions and equivalence assertions.

3. The method of claim 1, wherein said selection of marks comprise a palette of visually associative representations of said different associative informations, said selection of marks being displayed and selectable for applying individually to said item of information or selectable for applying a plurality of said marks to said at least one item of information at once.

4. The method of claim 3, wherein said palette of visually associative representations are selected from the group consisting of emoji, icons, emoticons and smileys.

5. The method of claim 1, wherein said item of information is selected from the group consisting of an image, a document, a computer-stored collection of information, and a link.

6. The method of claim 1, wherein said marking is applied to said item of information at or during its creation.

7. The method of claim 2, wherein said item of information is recorded as a duplicate of another item of information using said equivalence assertion.

8. The method of claim 7, wherein any of said associations recorded for said duplicate and said another item of information are coalesced in said UI and propagated to each other.

9. The method of claim 1, further comprising propagating said association to said plurality of cloud services.

10. The method of claim 9, further comprising prompting an owner of said item of information to accept or reject said association which originated from a source other than said owner.

11. A system for marking information aggregated from across multiple computer storage facilities and/or devices comprising:
a user interface on a computing device for displaying, conveying or creating at least one item of information;
a selection of marks for applying to said item of information, said selection comprises marks for identifying representation of different associative informations;
at least one mark for potentially describing said item of information and an association between the item of information and said at least one mark is stored on said computing device;
wherein said association stores metadata describing said item of information with said associative informations and is recorded in a consistent manner which disambiguates the origin, timing and priority of said metadata across a plurality of computing devices or cloud services to enable resolution of conflicting information and agglomeration of non-conflicting information using an assertion selected from the group consisting of property assertions, multiple property assertions and equivalence assertions.

12. The method of claim 11 further comprising performing an organizational task in said system and mirroring said organizational task on said multiple cloud services and/or devices.

13. The method of claim 11, wherein said association is stored as a logical assertion which identifies an agent originating said logical assertion.

14. The method of claim 13, wherein said logical assertion identifies the level of trust for said agent originating said logical assertion.

15. (canceled)

16. A method for managing information files stored on multiple storage facilities by a user without separately logging in or accessing each of the locations, each time by the user, comprising:
downloading an app onto a device;
establishing sources of information files that are to be managed by said app;
utilizing said app to access said information files in said sources through a proper application programming interface (API); and
displaying all of information files accessible to said user within said app.

17. The method of claim 16 further comprising:
automatically capturing and accepting metadata associated with said information files via said APIs and/or metadata embedded in said information files and storing said metadata as a series of assertions in a database;
allowing the user to manage and add assertions in said database;
retrieving information files based on said metadata by interpreting said assertions relative to their priority to deduce implied metadata that the user believes is true; and
propagating metadata between the device and said storage facilities through aggregation of said assertions.

18. The method of claim 16, further comprising employing said app to apply an organizational scheme from storage facility or device to another.

19. The method of claim 17, wherein said assertions do not affect said information file at its source.

20. The method of claim 17, further comprising creating and/or syncing duplicates or backups of said information files across said multiple storage facilities using said propagation of said metadata.

21. The method of any of claim 16 wherein said device comprises a smartphone, a tablet computer, a personal computer, or other communication or computing device.
